(19) United States
(12) Patent Application Publication
(10) Pub. No.: US 2022/0123403 A1
(43) Pub. Date: Apr. 21, 2022

(54) BATTERY PACK

(71) Applicants: HYUNDAI MOTOR COMPANY, SEOUL (KR); KIA CORPORATION, SEOUL (KR)

(72) Inventors: Jong Wook Lee, Hwaseong-si (KR); Tae Hyuck Kim, Asan-si (KR); In Gook Son, Hwaseong-si (KR); Hyeon Jun Kim, Hwaseong-si (KR); Yun Ho Kim, Suwon-si (KR)

(21) Appl. No.: 17/411,509

(22) Filed: Aug. 25, 2021

(30) Foreign Application Priority Data
Oct. 20, 2020 (KR) 10-2020-0136236

(51) Int. Cl. H01M 50/209; B60L 50/64; B60L 50/60

(52) U.S. Cl. CPC H01M 50/209; H01M 2220/20; B60L 50/66; B60L 50/64

(57) ABSTRACT

A battery pack includes a case, a longitudinal member longitudinally disposed within the case, and a plurality of battery modules, which are arranged in the case in a transverse direction of the case so as to define a plurality of rows of battery modules, wherein the longitudinal member divides an area in which the plurality of battery modules included in the plurality of rows are disposed into a first area and a second area, and a number of the battery modules included in the first area of one row among the plurality of rows is different from a number of the battery modules included in the second area in the one row.

### CROSS REFERENCE TO RELATED APPLICATIONS

This application claims the priority benefit of Korean Patent Application No. 10-2020-0136236, filed on Oct. 20, 2020, in the Korean Intellectual Property Office, the disclosure of which is incorporated herein by reference.

### BACKGROUND

### 1. Field

The present disclosure relates to a battery pack, and more particularly to a battery pack capable of reducing the size and manufacturing cost thereof by efficient arrangement of components.

### 2. Description of the Related Art

In recent years, in response to the global trend toward reduction of carbon-dioxide emissions, demand is rapidly increasing for an electrical vehicle, which creates power by driving a motor using electrical energy charged in a battery, in place of a typical internal combustion engine vehicle, which creates power through combustion of fossil fuel.

The performance of an electrical vehicle mainly depends on the capacity and performance of a battery for storing electrical energy to be supplied to a drive motor. Although the distance that the electrical vehicle can travel is increased as the capacity of the battery is increased, there are restrictions related to the space in the vehicle which can accommodate the battery therein.

Accordingly, the field of electrical vehicle demands technology for implementing a layout for high-density arrangement of battery modules in a battery pack provided in an electrical vehicle and for efficient arrangement of components constituting the battery for the purpose of increasing the performance of the electrical vehicle.

Details described as the background art are intended merely for the purpose of promoting understanding of the background of the present disclosure, and should not be construed as an acknowledgment of the prior art that is previously known to those of ordinary skill in the art.

### SUMMARY

Therefore, the present disclosure has been made in view of the above problems, and it is an object of the present disclosure to provide a battery pack which is capable of increasing power density by efficiently disposing components, such as battery modules and relay modules, in a case thereof and of reducing the size and manufacturing cost thereof by reducing the number of components required for management of the components.

In accordance with the present disclosure, the above and other objects can be accomplished by the provision of a battery pack including a case, a longitudinal member longitudinally disposed within the case, and a plurality of battery modules, which are arranged in the case in a transverse direction of the case so as to define a plurality of rows of battery modules, wherein the longitudinal member divides the area in which the plurality of battery modules included in the plurality of rows are disposed into a first area and a second area, and the number of battery modules included in the first area of one row among the plurality of rows is different from the number of battery modules included in the second area in the one row.

In an embodiment of the present disclosure, the battery pack may further include a plurality of cell management units, which are mounted on the longitudinal member and each of which monitors the voltage of some of the plurality of battery modules.

In an embodiment of the present disclosure, each of the plurality of cell management units may monitor only a plurality of battery modules included in the first area or only a plurality of battery modules included in the second area.

In an embodiment of the present disclosure, a first cell management unit among the plurality of cell management units may monitor a plurality of battery modules included in the first area of one row among the plurality of rows, and a second cell management unit of the plurality of cell management units may monitor a plurality of battery modules included in the second areas of at least two rows among the plurality of rows.

In an embodiment of the present disclosure, the ratio of the number of battery modules included in the first area of one row among the plurality of rows to the number of battery modules included in the second area of the one row may be 2:1.

In an embodiment of the present disclosure, a first cell management unit among the plurality of cell management units may monitor a plurality of battery modules included in the first area of at least one row among the plurality of rows, and a second cell management unit among the plurality of cell management units may monitor a plurality of battery modules included in the second areas of a plurality of rows among the plurality of rows, the number of rows in which the plurality of battery modules that are monitored by the second cell management unit are included being twice the number of the at least one row in which the plurality of battery modules that are monitored by the first cell management unit are included.

In an embodiment of the present disclosure, the battery pack may further include one or more transverse members disposed between the plurality of rows, a bracket, which is disposed between the transverse members or between one of the transverse members and an end of the case and is fixed thereto, and a power relay assembly fixed on the bracket.

In an embodiment of the present disclosure, the battery pack may further include a high-voltage connector, which transmits power of the battery modules to an outside of the battery pack or receives power required to charge the battery modules from an outside, and a battery management system connector, which sends and receives a signal to manage the battery modules to and from an external battery management system, wherein the high-voltage connector and the battery management system connector are integrally manufactured into a single block.

### BRIEF DESCRIPTION OF THE FIGURES

The above and other objects, features and other advantages of the present disclosure will be more clearly understood from the following detailed description taken in conjunction with the accompanying drawings, in which:

FIG. 1 is a plan view illustrating a battery pack according to an embodiment of the present disclosure;

FIG. 2 is a view schematically illustrating arrangement of battery modules and cell management units of the battery pack according to an embodiment of the present disclosure;

FIG. 3 is a plan view illustrating an area in which a power relay assembly of the battery pack according to an embodiment of the present disclosure is mounted; and

FIGS. 4 and 5 are views illustrating a high-voltage connector and a battery management system connector of the battery pack according to an embodiment of the present disclosure.

### DETAILED DESCRIPTION

Reference will now be made in detail to the preferred embodiments of the present disclosure, examples of which are illustrated in the accompanying drawings. Wherever possible, the same reference numbers will be used throughout the drawings to refer to the same or like parts.

Hereinafter, battery packs according to various embodiments of the present disclosure will be described in detail with reference to the accompanying drawings.

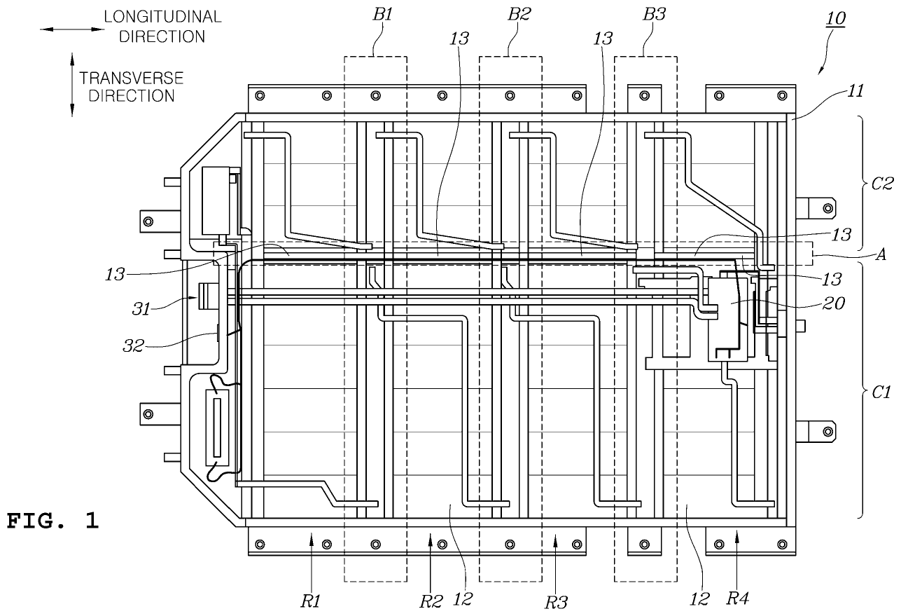

FIG. 1 is a plan view of a battery pack according to an embodiment of the present disclosure.

Referring to FIG. 1, the battery pack 10 according to an embodiment of the present disclosure may include a case 11 for accommodating battery modules 12 therein, battery modules 12 disposed inside the case 11, and a longitudinal member A, disposed in the space in the case 11, in which the battery modules 12 are accommodated, in the longitudinal direction of the case 11.

The case 11 may have a form including a lower panel and a side wall member fixed to the peripheral edge of the lower panel, and may accommodate the battery modules 12 in the space defined by the lower panel and the side wall member. The case 11 may be made of aluminum for the purpose of weight reduction.

The case 11 may be provided therein with a longitudinal member A for increasing the longitudinal rigidity of the case 11. The longitudinal member A may take the shape of a bar that extends in the longitudinal direction of the case 11 in the case 11. The longitudinal member A may be fixed to the lower panel of the case 11, and may be fixed at the two ends thereof to the side wall member. The longitudinal member A may comprise the same material as that of the case 11.

Each of the battery modules 12 may be a unit structure constituting the battery pack, and may include a plurality of battery cells. Each of the battery cells may be an element adapted to output the minimum unit voltage. The battery module 12 may be manufactured such that a plurality of battery cells are stacked one on another, the stacked structure of the battery cells is externally pressed by a rigid structure, and terminals are formed so as to electrically connect the battery cells to external components. The specific shape or structure of the battery module 12 may differ depending on vehicle make or model. The battery pack 10 may be manufactured in such a way as to prepare a plurality of battery modules 12, which are manufactured in the above-described way, and to electrically connect the battery modules 12 to each other so as to output a desired level of voltage.

In an embodiment of the present disclosure, a plurality of battery modules 12 may be arranged in the transverse direction of the case 11 to define at least one row. FIG. 1 illustrates an embodiment in which a total of four rows R1 to R4 are provided.

The battery modules 12 included in each of the four rows R1 to R4 may be divided into battery modules 12 included in a first area C1 and battery modules 12 included in a second area C2 by the longitudinal member A.

In an embodiment of the present disclosure, among the battery modules included in one row, the number of battery modules included in the first area C1 may be different from the number of battery modules included in the second area C2. In other words, in one embodiment of the present disclosure, the longitudinal member A is not disposed at the center of the case 11 in the transverse direction but is disposed to deviate from the center of the case 11 in the transverse direction. In one row of battery modules, the number of battery modules 12 positioned to the left of the longitudinal member A may be different from the number of battery modules 12 positioned to the right of the longitudinal member A.

The battery pack according to an embodiment of the present disclosure includes a plurality of cell management units (CMU) 13, which are disposed at the longitudinal member A to respectively monitor voltages of some of the plurality of battery modules 12.

Each of the cell management units 13 may monitor multiple battery modules 12, and the number of battery modules 12 that can be monitored by one cell management unit 13 may be limited.

In some embodiments, each of the cell management units 13 monitor battery modules 12 positioned in only one of the two areas, which are delimited by the longitudinal member A. This is because, when each of the cell management units 13 monitors battery modules 12 positioned in both areas, the circuit configuration becomes complicated and the possibility of error occurrence is increased due to the additional wiring.

Considering that the number of battery cells that can be monitored by one cell management unit 130 and the position at which the cell management unit 13 is disposed are limited, one of the cell management units 13 may be wired so as to monitor the battery modules 12 included in the first area C1 of one row, and another of the cell management units 13 may be wired so as to monitor the battery modules 12 included in the second areas C2 of two rows.

The battery pack according to an embodiment of the present disclosure may include transverse members B1 to B3, which are disposed between the rows R1 to R4. The transverse members B1 to B3 may serve to increase the transverse rigidity of the case 11. Each of the transverse members B1 to B3 may take the shape of a bar that extends in the case 11 in the transverse direction of the case 11. Each of the transverse members B1 to B3 may be fixed to the lower panel, and may be fixed at the two ends thereof to the side wall member. The transverse members B1 to B3 may comprise the same material as the case 110.

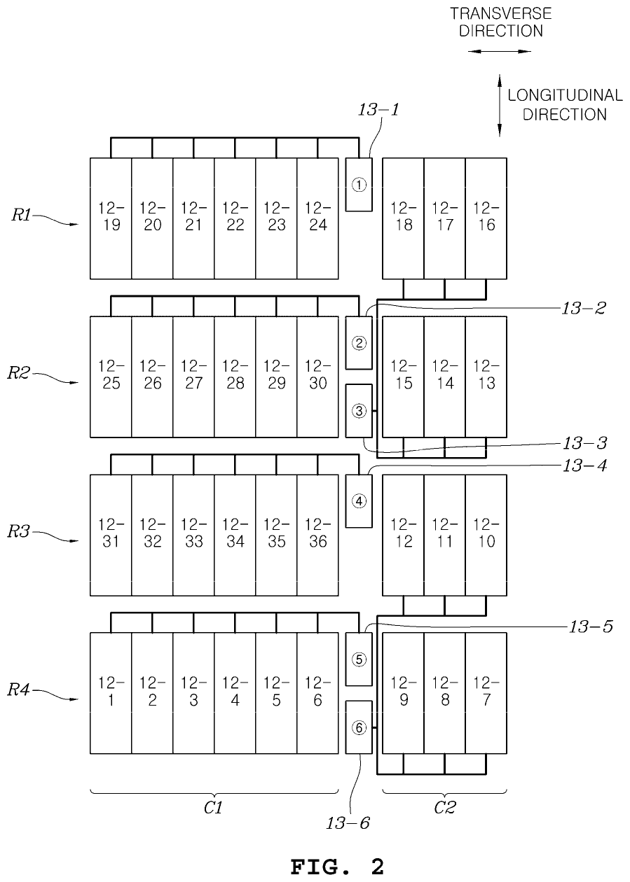

FIG. 2 is a view schematically illustrating the arrangement of the battery modules and the cell management units of the battery pack according to an embodiment of the present disclosure.

As illustrated in FIG. 2, in the case of a battery pack in which each of the four rows R1 to R4 includes nine battery modules among the battery modules 12-1 to 12-36, six battery modules may be disposed in the first area C1 and three battery modules may be disposed in the second area C2.

Specifically, six battery modules 12-19 to 12-24 may be disposed in the first area C1 of the first row R1, and three battery modules 12-16 to 12-18 may be disposed in the second area C2 of the first row R1. Six battery modules 12-25 to 12-30 may be disposed in the first area C1 of the second row R2, and three battery modules 12-13 to 12-15 may be disposed in the second area C2 of the second row R2. Six battery modules 12-31 to 12-36 may be disposed in the first area C1 of the third row R3, and three battery modules 12-10 to 12-12 may be disposed in the second area C2 of the third row R3. Finally, six battery modules 12-1 to 12-6 may be disposed in the first area C1 of the fourth row R4, and three battery modules 12-7 to 12-9 may be disposed in the second area C2 of the fourth row R4.

The longitudinal member A, which is positioned between the first area C1 and the second area C2, may be provided with the cell management units 13-1 to 13-6.

The first cell management unit 13-1 may monitor six battery modules 12-19 to 12-24 disposed in the first area C1 of the first row R1, and the second cell management unit 13-2 may monitor six battery modules 12-25 to 12-30 disposed in the first area C1 of the second row R2. The third cell management unit 13-3 may monitor three battery modules 12-16 to 12-18 disposed in the second area C2 of the first row R1 and three battery modules 12-13 to 12-15 disposed in the second area C2 of the second row R2.

Similarly, the fourth cell management unit 13-4 may monitor six battery modules 12-31 to 12-36 disposed in the first area C1 of the third row R3, and the fifth cell management unit 13-5 may monitor six battery modules 12-1 to 12-6 disposed in the first area C1 of the fourth row R4. Finally, the sixth cell management unit 13-6 may monitor three battery modules 12-10 to 12-12 disposed in the second area C2 of the third row R3 and three battery modules 12-7 to 12-9 disposed in the second area C2 of the fourth row R4.

In this embodiment, each of the cell management units 13-1 to 13-6 may monitor at most six battery modules.

In the case in which the battery modules that are transversely disposed in one row are arranged at a ratio of 2:1 on two sides of the longitudinal member A and each of the plurality of cell management units provided at the longitudinal member A is wired to monitor battery modules disposed at one side of the longitudinal member A such that battery modules disposed in the first area C1 of one row are connected to one cell management unit and battery modules disposed in the second areas C2 of two rows are connected to another cell management unit, it is possible to minimize the number of cell management units and to realize an optimal battery layout in which wiring across the longitudinal member A is avoided.

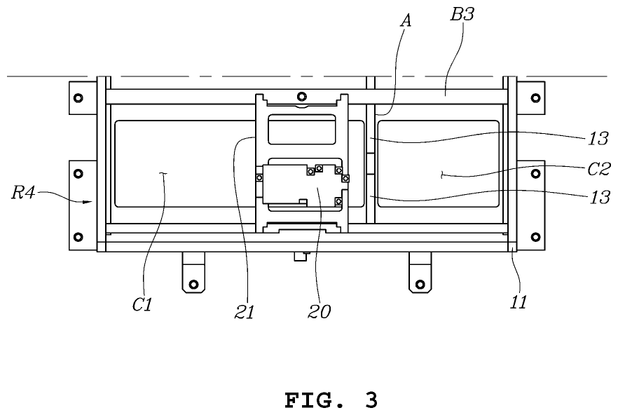

FIG. 3 is a plan view illustrating an area in which a power relay assembly of the battery pack according to an embodiment of the present disclosure is mounted.

The battery pack according to an embodiment of the present disclosure may include the power relay assembly 20. The power relay assembly 20 is a component including a plurality of relays adapted to establish electrical connection between the plurality of battery modules 12 and an external component. For example, when the power supply of an electrical vehicle is turned on, the relays included in the power relay assembly may be shorted such that the power generated from the battery modules 12 is transmitted to an external component of the battery pack (for example, a high-voltage component such as an inverter). When the power supply of the electrical vehicle is turned off, the relays included in the power relay assembly may be opened such that the electrical connection between the battery modules 12 and the components of the electrical vehicle is interrupted.

The power relay assembly 20 may include two main relays adapted to directly and electrically connect a positive (+) terminal and a negative (−) terminal of the overall structure, in which the battery modules 12 are connected to each other, to an external component, and an initial-charge relay, which is connected to two ends of one of the two main relays (mainly, the main relay connected to the positive (+) terminal) via a resistor. The initial-charge relay, which is shorted so as to serve as the main relay while a capacitor constituting a high-voltage bus is charged when the power supply of the electrical vehicle is turned on, may serve to allow current to flow via the resistor, thereby preventing damage to a system connected to the battery pack caused by overcurrent.

Conventionally, a power relay assembly is disposed in the additional space in the battery pack 10 so as to be aligned with the battery module 12. Hence, in the conventional technology, in order to provide additional space to mount the power relay assembly, the size of the case of the battery pack must be increased and thus the amount of unusable space is also inevitably increased.

In an embodiment of the present disclosure, the power relay assembly 20 is mounted on the battery module 12 via a bracket 21. The bracket 21 may be fixed to the case 11 or the transverse member B3 mounted in the case 11, and the power relay assembly 20 may be fixed to the upper portion of the bracket 21.

By virtue of the structure in which the power relay assembly 20 is disposed on the battery module 12, it is possible to reduce the size and weight of the case 11 of the battery pack 10 and to minimize the amount of unusable space in the battery pack 10.

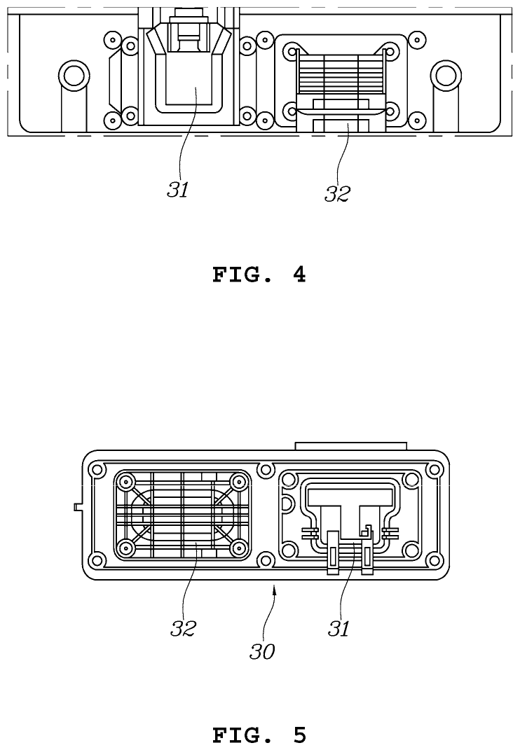

FIGS. 4 and 5 are views illustrating a high-voltage connector and a battery management system (BMS) connector of the battery pack according to an embodiment of the present disclosure.

Specifically, FIG. 4 is a view illustrating the connectors, which are exposed outwards from the battery pack 10, and FIG. 5 is a view illustrating the connectors, which are incorporated into an integral block. When the integral block shown in FIG. 5 is fastened to the battery pack 10, the connectors may be viewed as shown in FIG. 3 when viewed from the outside of the battery pack 10.

The battery pack 10 may be provided with the high-voltage connector 31, adapted to output power generated by the battery modules 12 provided in the battery pack 10 or to receive charging power from the outside, and the BMS connector 32, adapted to receive the monitored voltage of the battery module 12 in the battery pack 10 and to send and receive signals with respect to the battery management system (BMS), which performs overall management such as monitoring of the battery state and control of the battery output.

The high-voltage connector 31 may be electrically connected to the positive (+) terminal and the negative (−) terminal of the power relay assembly 20, and the BMS connector 32 may be electrically connected to various components, which are provided so as to perform control of the battery state such as voltage balancing between the cell management units 13, between the battery modules 12 or between the battery cells in the battery modules 12, which are mounted in the battery pack 10.

In the conventional technology, the high-voltage connector and the BMS connector are separately prepared into respective blocks, and are separately attached to the battery pack 10 for use. Hence, the conventional technology requires sufficient space to separately accommodate the connectors therein.

In contrast, according to the present disclosure, since the high-voltage connector 31 and the BMS connector 32 are integrally formed into a single block, as illustrated in FIG. 5, it is possible to simplify the structure required to fasten the separate blocks and to reduce the amount of space required to fasten the separate blocks. As a result, it is also possible to reduce the weight of the case of the battery pack.

As is apparent from the above description, the present disclosure provides a battery pack in which battery modules, which are transversely disposed in one row, are arranged at a ratio of 2:1 on two sides of the longitudinal member and in which each of a plurality of cell management units provided at the longitudinal member are wired so as to monitor battery modules disposed on one side of the longitudinal member such that battery modules disposed in a first area of one row are connected to one cell management unit and battery modules disposed in second areas of two rows are connected to one cell management unit, making it possible to minimize the number of cell management units and to realize an optimal battery layout in which wiring across the longitudinal member is avoided.

Furthermore, according to the present disclosure, by virtue of the structure in which the power relay assembly is mounted on the battery module via the bracket, it is possible to reduce the size and weight of the case of the battery pack and to minimize the amount of unusable space in the battery pack.

In addition, according to the present disclosure, since the high-voltage connector and the BMS connector are integrally formed into a single block, it is possible to simplify the structure required to fasten the separate blocks and to reduce the amount of space required to fasten the separate blocks. Therefore, it is also possible to reduce the weight of the case of the battery pack.

The effects that can be obtained by the present disclosure are not limited to the above-mentioned effects, and other effects, which are not mentioned above, will be apparent to those skilled in the art to which this disclosure belongs.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

1. A battery pack comprising:
a case;
a longitudinal member longitudinally disposed within the case; and
a plurality of battery modules arranged in the case in a transverse direction of the case to define a plurality of rows of battery modules;
wherein the longitudinal member divides an area in which the plurality of battery modules included in the plurality of rows are disposed into a first area and a second area, and a number of the battery modules included in the first area of one row among the plurality of rows is different from a number of the battery modules included in the second area in the one row.

2. The battery pack according to claim 1, further comprising a plurality of cell management units mounted on the longitudinal member, and each of the plurality of cell management units being configured to monitor voltages of some of the plurality of battery modules.

3. The battery pack according to claim 2, wherein each of the plurality of cell management units is configured to monitor only a plurality of battery modules included in the first area or only a plurality of battery modules included in the second area.

4. The battery pack according to claim 2, wherein a first cell management unit among the plurality of cell management units is configured to monitor a plurality of battery modules included in the first area of one row among the plurality of rows, and a second cell management unit of the plurality of cell management units is configured to monitor a plurality of battery modules included in the second areas of at least two rows among the plurality of rows.

5. The battery pack according to claim 2, wherein a ratio of a number of battery modules included in the first area of one row among the plurality of rows to a number of battery modules included in the second area of the one row is 2:1.

6. The battery pack according to claim 5, wherein a first cell management unit among the plurality of cell management units is configured to monitor a plurality of battery modules included in the first area of at least one row among the plurality of rows, and a second cell management unit among the plurality of cell management units is configured to monitor a plurality of battery modules included in the second areas of a plurality of rows among the plurality of rows, a number of the rows in which the plurality of battery modules that are monitored by the second cell management unit are included being twice a number of the at least one row in which the plurality of battery modules that are monitored by the first cell management unit are included.

7. The battery pack according to claim 1, further comprising:
one or more transverse members disposed between the plurality of rows;
a bracket disposed between the transverse members or between one of the transverse members and an end of the case, and is fixed thereto; and
a power relay assembly fixed on the bracket.

8. The battery pack according to claim 1, further comprising:
a high-voltage connector configured to transmit power of the battery modules to an outside of the battery pack, or configured to receive power required to charge the battery modules from an outside; and
a battery management system connector configured to send and receive a signal to manage the battery modules to and from an external battery management system;
wherein the high-voltage connector and the battery management system connector are integrally manufactured.
